(19) United States
(12) Patent Application Publication
(10) Pub. No.: US 2007/0250382 A1
(43) Pub. Date: Oct. 25, 2007

(54) Responsibilities-based reward allocation and management system

(75) Inventor: Harvey Beck, Ontario (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hablar Holdings Ltd., Toronto (CA)

(21) Appl. No.: 11/407,564

(22) Filed: Apr. 19, 2006

(51) Int. Cl. G06Q 30/00

(52) U.S. Cl. 705/14

(57) ABSTRACT

A method and apparatus for a responsibilities-based reward allocation and management system. The system provides a responsibilities setup mechanism for configuring a plurality of responsibilities and/or responsibility categories or groups. The system provides a mechanism for setting up a plurality of bank accounts or a plurality of expense categories for the responsibility categories. Performance of responsibilities results in a point total, and rewards being allocated to the bank accounts based on the point total. The system includes a budget allocation mechanism for allocating or dividing the reward to the plurality of bank accounts. The system further includes a facility for withdrawing funds from selected ones of the accounts.

### FIELD OF THE INVENTION

The present invention relates to computer-based systems, and more particularly to a system and methods for a responsibilities-based rewards allocation and management system.

### BACKGROUND OF THE INVENTION

Raising responsible and respectful children is a goal of all parents, and to this day remains one of the greatest challenges faced by parents. In its simplest form, teaching responsibility to a growing child amounts to behavior modification. Parents have shown incredible resourcefulness and creativity to bring about the desired behavior in their growing children.

One universally employed technique involves rewarding a child for good behavior, and the loss of privileges for unacceptable behavior. The rewards may be non-monetary, for example, an ice cream cone or other treat for a young child, or monetary, for example, money for a movie for a teenager.

Another well-known type of reward is a weekly allowance. Frequently, a weekly allowance is tied to the child performing certain household tasks or chores, completing their homework on time, etc. The child earns the allowance and is then free to spend the money as they choose. As compared to a simple reward approach, the weekly allowance has the added benefit of tying the awarding of money to the performance of duties, and these duties become the responsibility of the child.

While parents have relied on these age-old techniques for developing a sense of responsibility and bringing about desired child behavior, it will be appreciated that these techniques are ad hoc at best. There remains a need for a structured approach, which not only addresses child behavior modification and responsibilities, but also teaches or combines other important life skills such as budgeting and financial management.

### BRIEF SUMMARY OF THE INVENTION

The present invention provides a responsibilities-based reward allocation and management system and method.

According to one aspect, the present invention comprises a system for allocating a reward based on a point total, the system comprises: a list having one or more responsibilities, and completion of each of the responsibilities provides a point towards the point total; two or more accounts, each of the accounts is adapted to accept the reward or a portion of the reward; a calculator for calculating the reward, the reward being based on the point total; and an allocator for allocating the reward between the two or more accounts.

According to another aspect, the present invention provides a method for allocating a reward based on a point total, the method comprises the steps of: providing a list comprising one or more responsibilities, wherein completion of each of the responsibilities results in a point for the point total; providing two or more accounts, each of the accounts being adapted for receiving the reward or a portion of the reward; calculating a reward amount based on the point total; and allocating the reward amount to the two or more accounts.

According to a further aspect, the present invention provides a network-based system for allocating a reward based on a point total, the system comprises: a server coupled to a network; the network includes a plurality of ports for coupling user stations to the network for communicating with the server; the server includes a component for generating a responsibilities list for any one of the users, the responsibilities list comprises one or more responsibilities, and completion of each of the responsibilities provides a point towards the point total; the user station includes a component for transmitting to the server a point total associated with the user station; the server includes a component for defining two or more accounts for any one of the users, each of the accounts being adapted for accepting the reward or a portion of the reward for the user associated with the accounts; the server includes a component for calculating the reward for the user based on the point total received from the user; the server includes a component for allocating the calculated reward to the two or more accounts associated with the user; and the server includes a component for sending a page to the user showing the allocation of the reward to the two or more accounts.

In yet another aspect, the present invention provides a system for allocating a reward based on a point total, the system comprises: a list comprising one or more responsibilities, wherein completion of each of the responsibilities provides a point towards the point total; a plurality of expense categories, each of the expense categories having an associated budget allocation; a plurality of accounts, each of the accounts being adapted to accept the reward or a portion of the reward according to the budget allocation; a calculator for calculating the reward, the reward being based on the point total and a budget allowance; and an allocator for allocating the reward between the accounts, the allocation being based on the budget allocation for the corresponding expense category.

In yet a further aspect, the present invention provides a computer data signal embodied in a carrier wave, the carrier wave comprises: a responsibilities-based reward allocation portal page code segment; the portal page code segment includes one or more member frames, and each of the member frames includes a responsibilities page code segment, a budget page code segment, and a point entry window.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference is now made to the accompanying drawings which show, by way of example, embodiments of the present invention, and in which:

FIG. 1 shows in diagrammatic form a responsibilities-based reward allocation and management system implemented on a networked computer system according to one embodiment of the present invention;

FIG. 2 shows in flowchart form a process for the responsibilities-based reward allocation and management system according to an embodiment of the present invention;

FIG. 3 is a screenshot of a login or sign-in page or window for an Internet (Web) based implementation of a responsibilities-based reward allocation and management system according to an embodiment of the present invention;

FIG. 4 is a screenshot of a setup page for the responsibilities-based reward allocation and management system according to an embodiment of the invention;

FIG. 5(a) is a screenshot of a main menu or home page, which is typically displayed after setup is completed according to an embodiment of the invention;

FIG. 5(b) is a screenshot of a page for adding a new member according to an embodiment of the invention;

FIG. 6 is a screenshot of a setup wizard page for creating a family or virtual bank according to an embodiment of the invention;

FIG. 7 is a screenshot of a setup wizard page for creating a budget for a family member according to an embodiment of the invention;

FIG. 8 is a screenshot of a page for creating the budget for a family member according to an embodiment of the invention;

FIG. 9 is a screenshot of the budget page of FIG. 8 showing an options drawer according to an embodiment of the invention;

FIG. 10 is a screenshot of a page for defining an expense category for the budgets page of FIG. 8 according to an embodiment of the invention;

FIG. 11 is a screenshot of a page for defining an expense item for one of the expense categories of FIG. 8 according to an embodiment of the invention;

FIG. 12 is a screenshot of a page displaying a formatted budget page which is ready for printing according to an embodiment of the invention;

FIG. 13 is a screenshot of a setup wizard page for creating a responsibilities checklist according to an embodiment of the invention;

FIG. 14 is a screenshot of a page for creating the responsibilities checklist, according to an embodiment of the invention;

FIG. 15 is a screenshot of a page displaying a formatted responsibilities checklist which is ready for printing, according to an embodiment of the invention;

FIG. 16 is a screenshot of a page for defining a responsibility category for the responsibilities checklist page of FIG. 14 according to an embodiment of the invention;

FIG. 17 is a screenshot of a page for creating a responsibility item for one of the responsibility categories in the responsibilities checklist page of FIG. 14 according to an embodiment of the invention;

FIG. 18 is a screenshot of a page for defining point allocation rules or procedures for a family member's budget according to an embodiment of the invention;

FIG. 19 is a screenshot of the point allocation page of FIG. 18 illustrating an unequal allowance percentage allocation, according to an embodiment of the invention;

FIG. 20 is a flowchart showing a process for allocating points according to an embodiment of the invention;

FIG. 21 is a screenshot of a portal providing access for a family member (e.g. a child) to the responsibilities-based reward allocation and management system, according to an embodiment of the invention;

FIG. 22(a) is a screenshot of a family member's (e.g. a child's) home page, according to an embodiment of the invention;

FIG. 22(b) is a screenshot of a messages window accessed from a family member's (e.g. a child's) home page of FIG. 22(a), according to an embodiment of the invention;

FIG. 23 is a screenshot of a child's check writing page, according to an embodiment of the invention; and

FIG. 24 is a screenshot of a child's print check view, according to an embodiment of the invention.

### DETAILED DESCRIPTION OF THE INVENTION

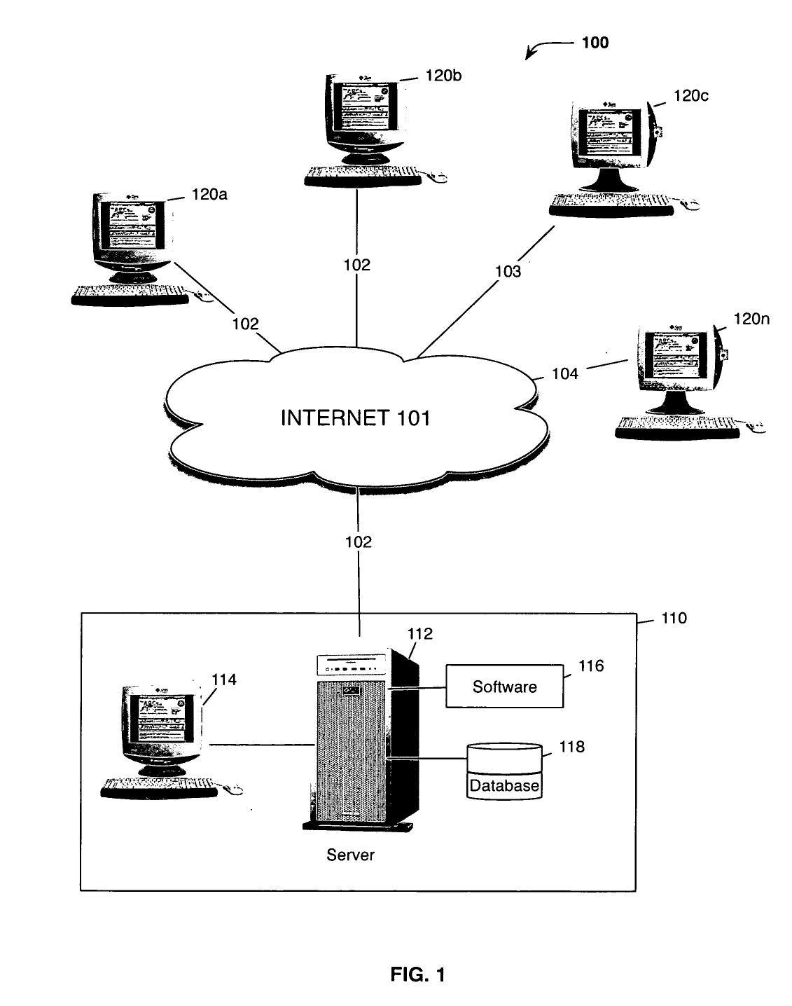

Reference is made to FIG. 1, which shows a network-based implementation for a responsibilities-based reward allocation and management system according to one embodiment of the invention and indicated generally by reference 100. It is to be appreciated that while the system 100 is described in the context of a network-based implementation, the system 100 may also be implemented as a stand-alone computer program or application.

As shown in FIG. 1, the responsibilities-based reward allocation and management system 100 comprises a central processor or web server 110 and a plurality of individual computers or workstations 120. The computers 120 are indicated individually by references 120a, 120b, 120c . . . 120n, and typically comprise a personal computer (e.g. desktop or notebook), which is located in the home of a user. The user is a person or family with access privileges, e.g. a subscriber, to the system 100. The central processor 110 and the computers are coupled together via a communication network indicated generally by reference 101. For this embodiment, the Internet provides the communication network 101. The computers 120 connect to the Internet 101 through an Internet Service Provider (ISP) or Internet Access Provider (IAP) via a digital subscriber line (DSL) 102 or a high-speed cable Internet connection 104 or dial-up. The connection to the Internet 101 may also include a wireless link (e.g. WIFI) as indicated by reference 103.

Referring to FIG. 1, the central processor or web server 110 comprises a server 112 and workstation 114. The server 112 is coupled to the communication network 101 (i.e. the Internet) for example through a DSL link 102. The server 112 includes one or more computer programs (i.e. software) indicated generally by reference 116 which generate and download web pages to the computers 120 as described in more detail. The computer programs 116 also include software for creating and managing accounts for the users or subscribers and other administrative functions. The workstation 114 is coupled to the server 112 and allows an administrator to perform maintenance and control functions associated with the system 100. As also shown, the server 112 can include one or more databases indicated generally by reference 118. The database 118 serves as a repository and archive facility for data associated with the system and/or subscribers, for exemplary web pages, for FAQs (Frequently Asked Questions), Parent Forums, Kids Forums, etc. The features and functional aspects of the system 100 are described in more detail below with reference to selected screenshots and flowcharts.

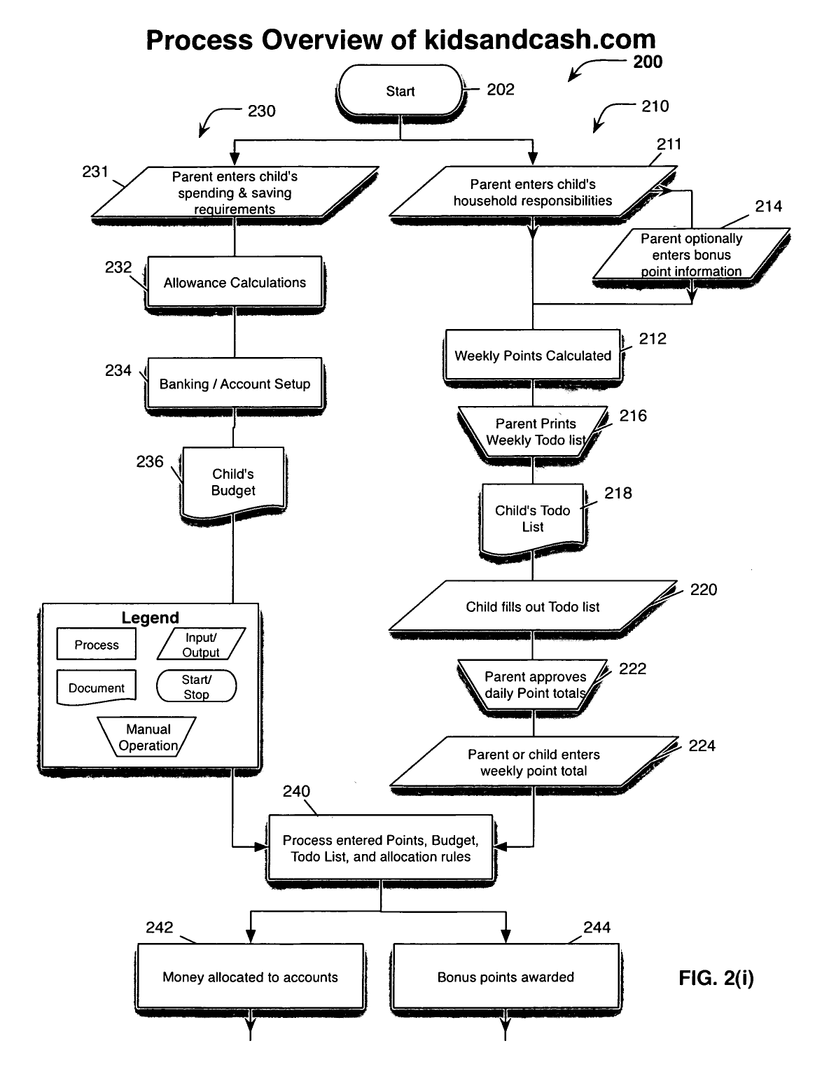

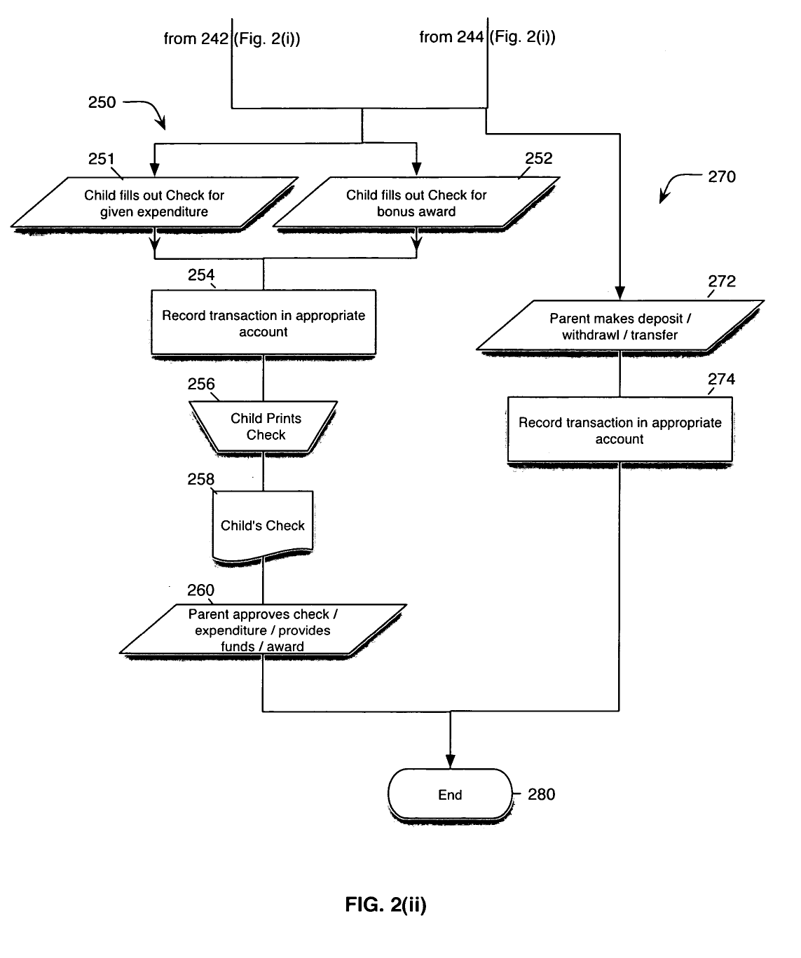

Reference is made to FIG. 2, which provides in flowchart form an overview of the operation of the responsibilities-based rewards allocation and management system 100. The process overview is indicated generally by reference 200 and comprises four principal functions. The first function indicated by reference 210 comprises managing a child's responsibilities. The second function indicated by reference 230 comprises managing a child's spending and saving requirements. The third function indicated by reference 250 comprises managing a child's withdrawals from their account(s). The fourth function indicated by reference 270 comprises managing deposits/withdrawals/transfers by a parent.

The child's responsibilities management function 210 is performed for each child or member, and comprises a setup function where a parent enters household responsibilities as indicated by block 211, for example, as described in more detail below with reference to a ‘Responsibilities’ page. The responsibilities are assigned to the child and weekly point totals are calculated by the system 100, as indicated by block 212. The parent may also enter activities or tasks, which result in bonus points being awarded, as indicated by block 214. Once the setup function has been completed, the parent or child prints the weekly responsibilities To-do lists (block 216) and each child is given their respective To-do list (block 218). Each child completes its To-do list, for example, on a daily basis, (block 220). The parent approves the Point totals (block 222) and the parent (or child) enters the point totals, for example on a weekly basis, into the system 100 (block 224).

The managing a child's spending and saving requirements function 230 also comprises a setup type function, which is performed by the parent. As indicated in block 231, the parent enters the spending and saving requirements or parameters for each child, for example, setting up various “expense categories” as described in more detail below with reference to the “Budget” page. The spending and saving requirements function 230 includes an allowance allocation mechanism (block 232) which is configured by the parent to allocate the earned reward(s) between the various expense categories or accounts, as also described in more detail below. The next step in block 234 involves the parent setting up a “virtual bank” and the accounts for each of the family members or children. Once set up, the system 100 provides the capability for the parent to print a “Budget” document or page for each of the children (block 236).

The computer program(s) (i.e. system software) 116 includes one or more functions, routines or code components, for processing the points entered for each child. As will be described in more detail below, the processing involves allocating rewards (e.g. money and/or bonus points) to the various expense categories in the child's Budget based on the allocation rules defined for the child (block 240). In addition to money allocated to the child's accounts (block 242), the reward may comprise bonus points being awarded (block 244), or other types of non-monetary rewards.

Referring still to FIG. 2, the computer program or software 116 (FIG. 1) includes code for the function 250 for managing withdrawals by a child from their account(s). The system allows a child to request a check for a given expenditure (block 251) or a check for a bonus award (block 252). The software includes a function for recording the transaction against the appropriate account (block 254) and a function for printing (block 256) the check, which may comprise a paper or hardcopy item or document as indicated by block 258. The parent approves and cashes the check printed by the child (block 260). Similarly for a non-monetary award, the parent provides the bonus, e.g. permission to watch television or play the XBox™ game, in exchange for the check.

The computer program or software 116 (FIG. 1) also includes functions or code for managing deposits/withdrawals/transfers function 270. As indicated generally by block 272, the parent manages the virtual bank in the system 100 by making deposits to the account(s) of each child, for example, based on the amounts earned by each child for fulfilling their responsibilities on the To-do lists. In the case of a young child, the parent makes withdrawals (and/or writes checks) from the virtual bank using the adult portal. The software 116 also provides the parent with the capability to transfer funds between accounts. As indicated by block 274, the software 116 includes code for recording transactions associated with the account(s) of any of the children.

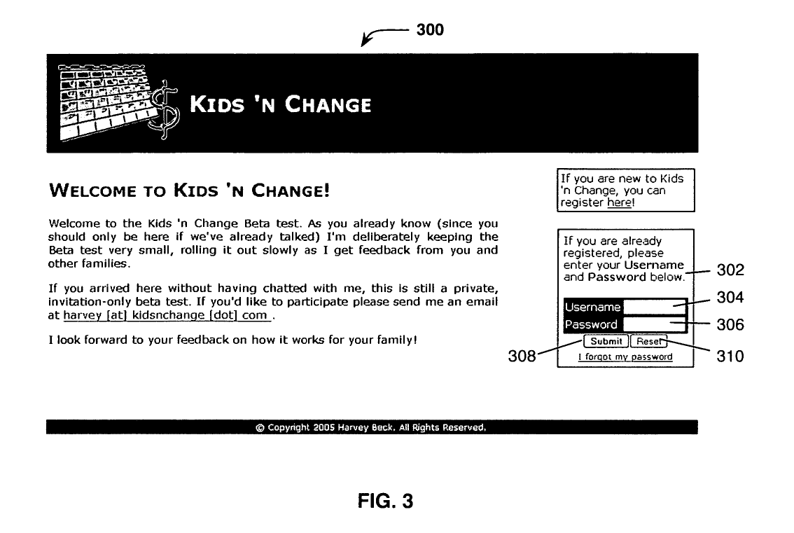

Reference is next made to FIGS. 3 to 25, which comprise screenshots of Web pages incorporating these and other functions associated with the responsibilities-based reward allocation and management system 100 according to embodiments of the invention. According to this embodiment of the system 100, the user interface and software components are implemented using a graphical user interface or GUI or using a web browser.

Reference is made to FIG. 3, which is a screenshot of a portal or web page 300 for accessing the system 100 (FIG. 1) over the Internet 101 (FIG. 1) according to an embodiment of the invention. As shown, the portal page 300 includes a log-on screen or frame 302. The log-on screen 302 serves to limit access to registered users. The log-on screen 302 comprises a Username input text box 304, a Password input text box 306, a Submit button 308, and a Reset button 310. The software functions or code for the log-on screen 302 may be implemented using conventional programming techniques as will be within the understanding of one skilled in the art.

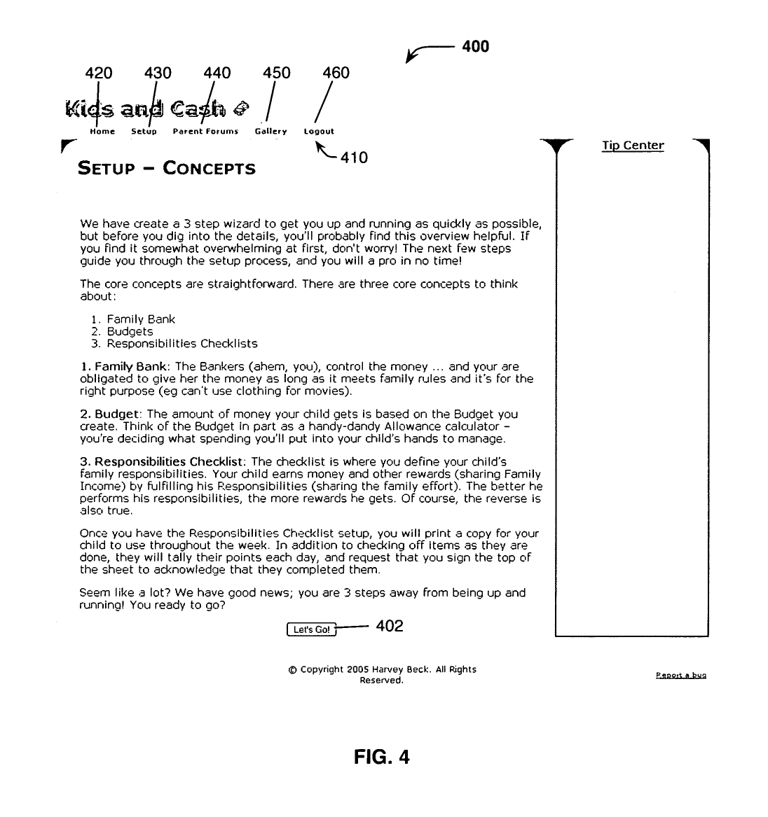

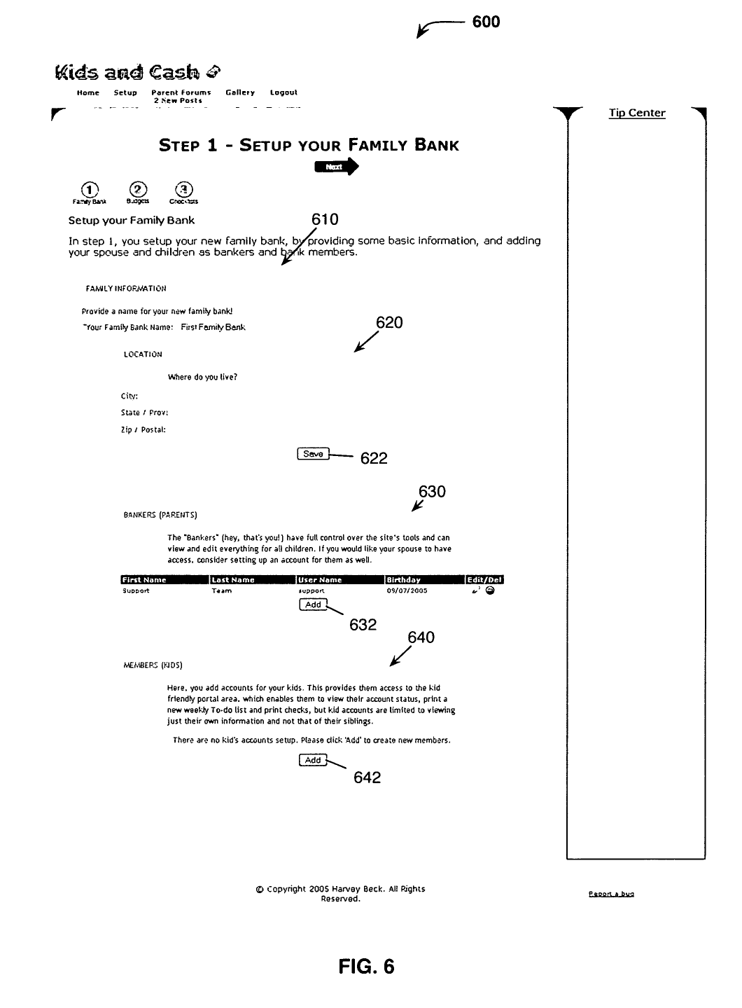

Reference is next made to FIG. 4, which is a screenshot of a setup wizard page indicated generally by reference 400. The system 100 may be configured to automatically display the setup wizard page 400 when a new user first logs onto the system 100. The setup wizard 400 facilitates the creation of a “Family Bank” (i.e. a Virtual Bank), a Budget for each family member and a Responsibilities Checklist for each family member. Alternatively, a user can access the setup wizard page 400 by clicking a “Setup” tab 430 in a toolbar 410. The setup page 400 also includes a “Home” tab 420, a “Parent Forums” tab 440, a “Gallery” tab 450, and a “Logout” tab 460 in the toolbar 410. To proceed with the setup, the setup wizard page 400 includes a “Let's Go” tab or button 402, which is clicked by the user to access a Setup Family Bank page 600 as described in more detail below with reference to FIG. 6.

Referring to FIG. 6, the Setup Your Family Bank page 600 includes the toolbar 410 (as described above) and comprises a Family Information window or frame 610 and a Location window or frame 620 for entering a name for the family bank and family address information, respectively. The Setup Your Family Bank page 600 also includes a Bankers setup window or frame 630 and a Members Accounts setup window or frame 640.

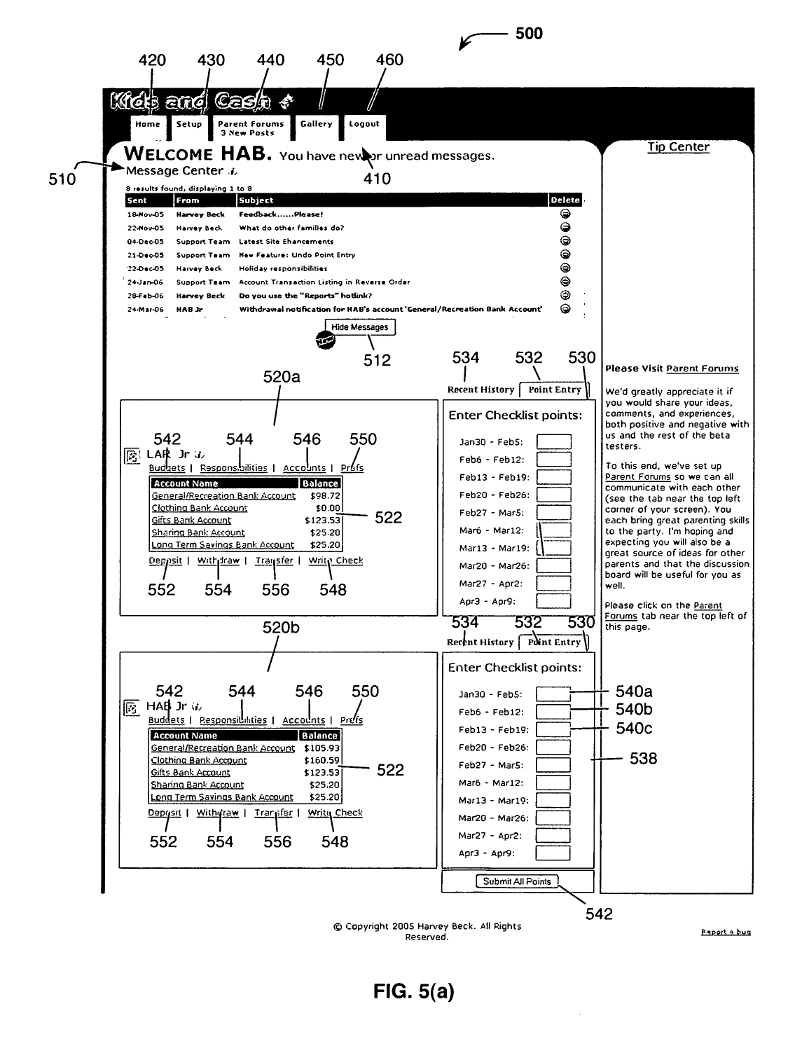

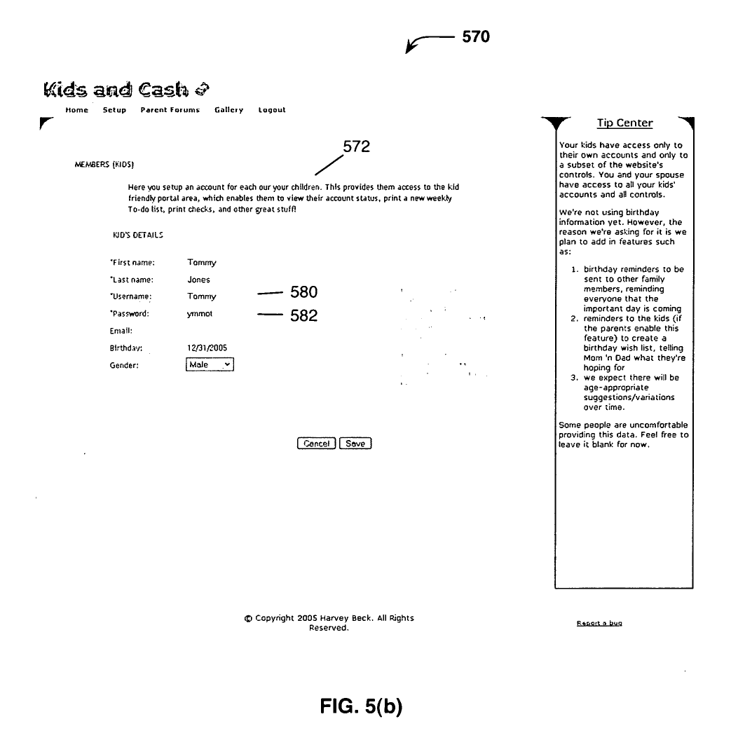

If the user has already run the setup wizard or created the family bank, budget(s) and responsibilities checklist(s), then in response to the logon, the system 100 displays a Home page of a form as shown in FIG. 5(a) and indicated generally by reference 500.

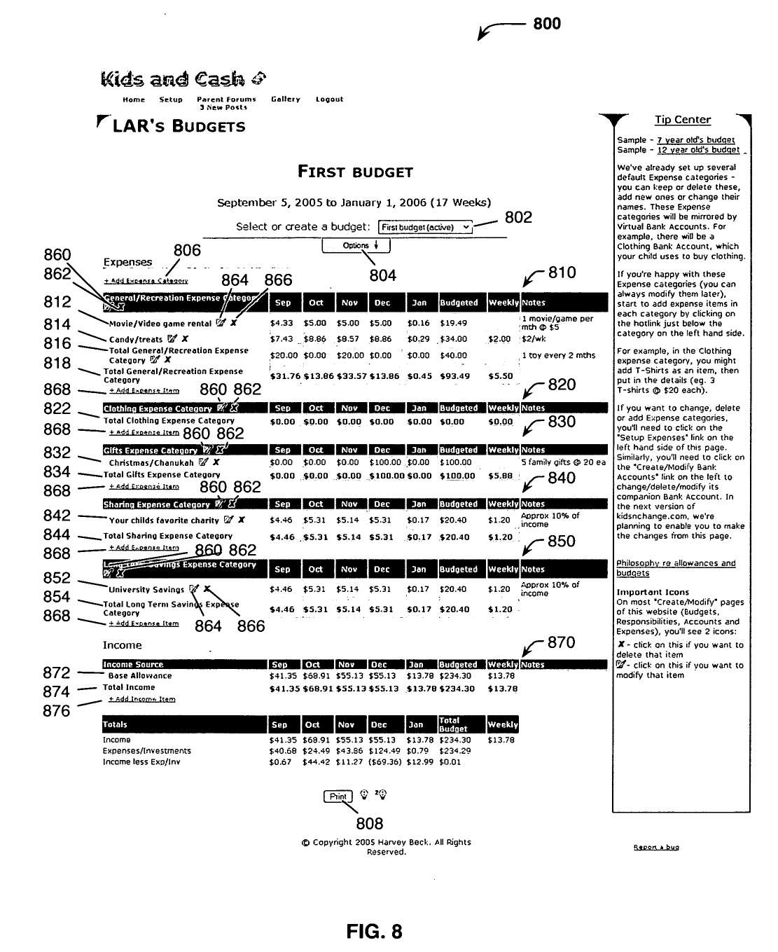

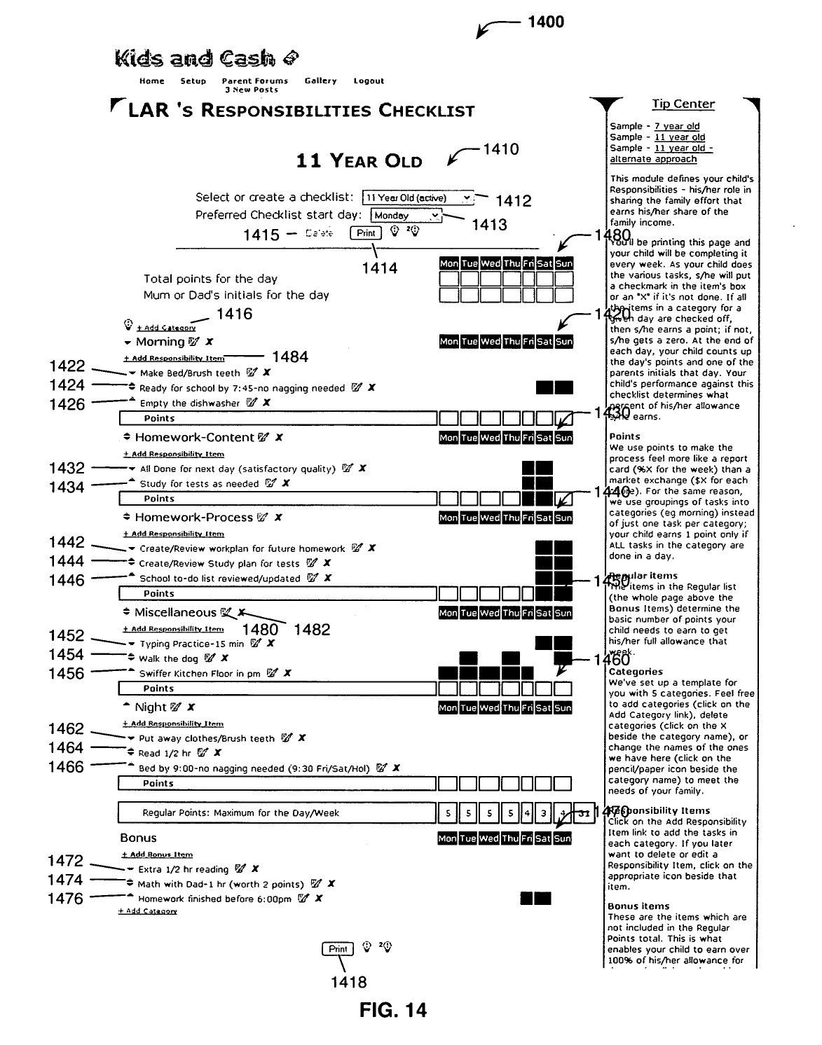

Referring to FIG. 5(a), the Home page 500 includes the toolbar 410 (as described above for FIG. 4). The Home page 500 also includes a Message Center window or frame 510, and a family member window or frame 520 for each registered child. The Message Center window 510 provides a list of messages, for example, from the system administrator, the support department, etc. The Message Center window 510 is closed or hidden by clicking a Hide Messages tab or button 512. For the embodiment depicted in FIG. 5(a), there is a family member window or frame 520a for LAR Jr. and a family member window or frame 520b for HAR Jr. As shown, the family member window 520 includes an Accounts window 522, which shows the names of the accounts that have been created or configured for a family member. The account names are implemented as hyperlinks (i.e. using the hypertext in HTML). This feature allows a user (i.e. a parent or a child) to access a transaction history or other information associated with the account by simply clicking the hypertext field. As also shown, the family member window 520 includes a Budgets hyperlink 542, a Responsibilities hyperlink 544, an Accounts hyperlink 546, a Write Check hyperlink 548, a Prefs (i.e. preferences) hyperlink 550, a Deposit hyperlink 552, a Withdraw hyperlink 554, and a Transfer hyperlink 556. Clicking the Budgets hyperlink 542 displays a Budgets page 800, for example, as shown in FIG. 8. Clicking the Responsibilities Checklist hyperlink 544 displays a Responsibilities Checklist page 1400, for example, as shown in FIG. 14. The features of these pages and other functions will become apparent from the description provided below.

As shown in FIG. 5(a), each of the family member windows 520 also includes an associated window 530. The associated window 530 includes a Points Entry tab 532 and a Recent History tab 534. Clicking the Points Entry tab 532b (i.e. for the second family member window 520b) displays an Enter Checklist Points window 538, which as shown includes a text input box 540 (indicated individually by references 540a, 540b, 540c,) for each week and a Submit All Points tab 542. As will be described in more detail below, a user, for example a parent, enters a weekly point total from the Responsibilities Checklist in each respective text box 540 and clicks the Submit All Points tab 542 to complete the entry.

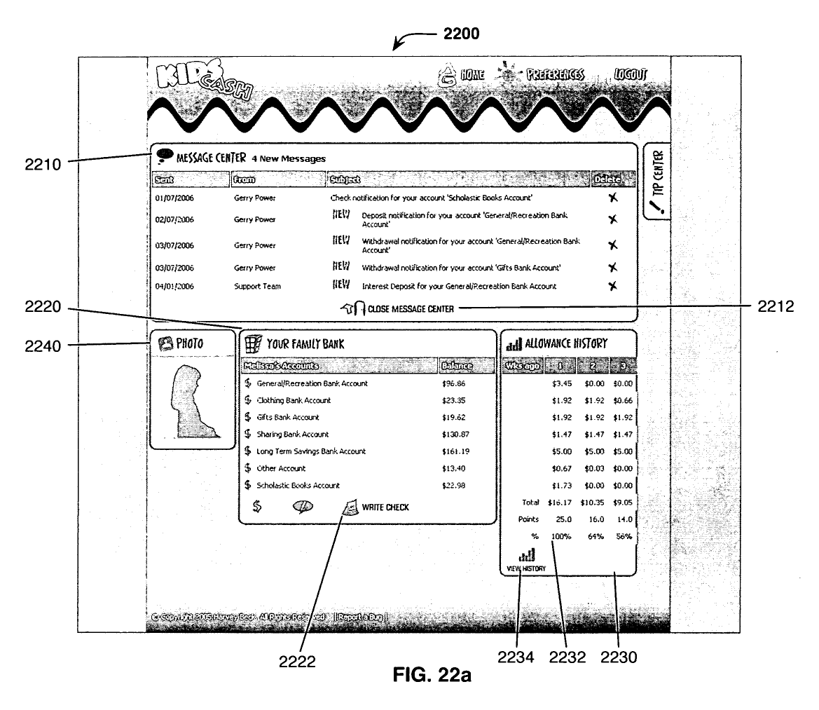

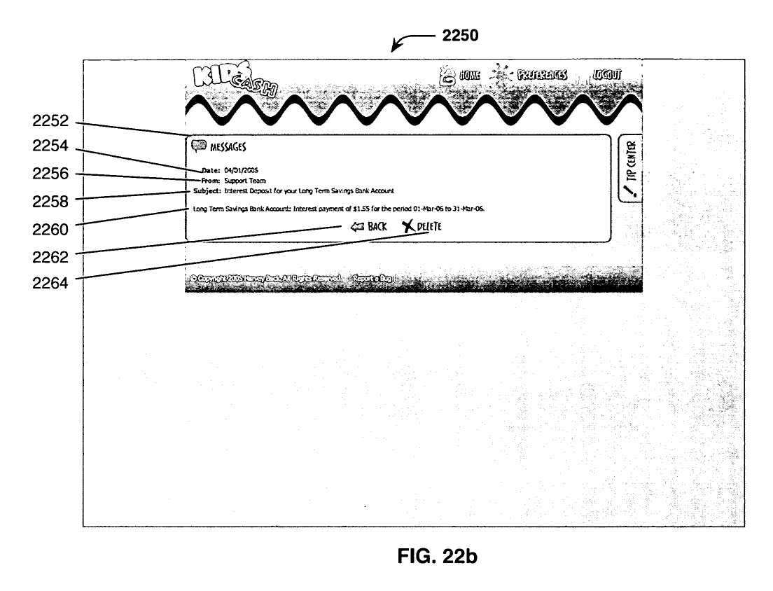

Referring to FIG. 5(a), clicking on the Recent History tab 534 displays a Recent History window, which may take the form as shown in FIG. 22(a). The Recent History window provides a summary of recent transactions/operations associated with a family member, such as an allowance history.

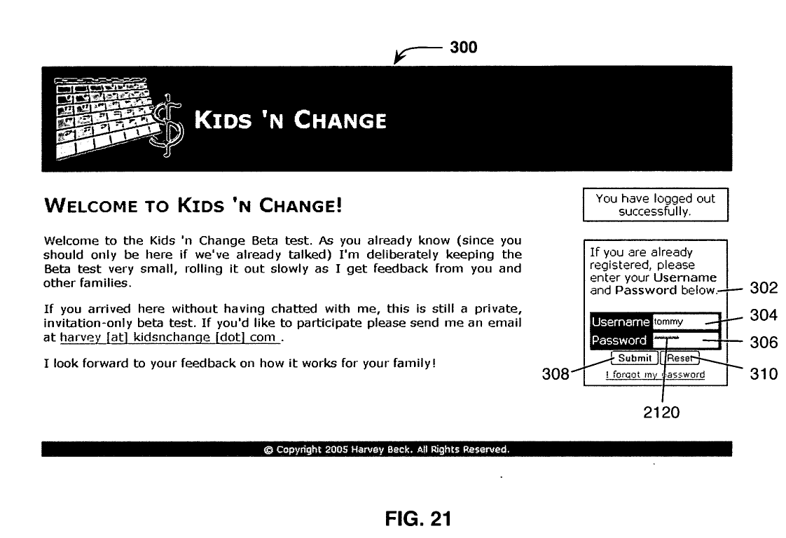

To add a new or other family member, the user clicks the Setup tab 430, which displays an Add a Family Member page 570 of a form, for example, as depicted in FIG. 5(b). As shown, the Add a Family Member page 570 includes the toolbar as described above and a window or frame 572 comprising a number of text input boxes for providing information about the additional family member. As shown, the text input boxes include a Username input box 580 and a Password input box 582 (and a Confirm Password input box 584), which allow a parent to configure access privileges for a child family member to access the system 100 through a Child portal as described in more detail below with reference to FIGS. 21 to 24. Once the new family member has been added, the user configures the respective responsibilities checklists and budgets as described in more detail below. (As described below, the setup family bank page 600 shown in FIG. 6 also includes an Add member button).

Reference is next made to FIG. 6, which is a screenshot of a family bank setup page indicated generally by reference 600. The family bank setup page 600 allows a banker (e.g. a parent) to set up virtual bank accounts for each of the members (e.g. kids). The family bank setup page 600 comprises a Family Information window or frame 610, a Location window or frame 620, a Bankers window or frame 630, and a Members accounts window or frame 640. The Family Information window 610 comprises a text input box for naming the “Family Bank”. The Location window 620 comprises text input boxes for entering an address associated with the Family Bank. Clicking a Save button 622 saves the information in memory, for example, on the server 112 (FIG. 1). The Bankers window 630 allows a parent to set up additional access privileges for another parent, e.g. a spouse. The spouse's first and last names are entered. The entered information may also include a user name and birthday. Clicking an Add button 632 adds the information. The Members accounts window 640 allows the parent (i.e. banker) to set up accounts for the members, for example, according to one embodiment an account for each expense category as described in more detail below with reference to the Budgets page in FIG. 8 and the Kids portal page in FIG. 22(a). For a first time setup or if the accounts have not yet been set up, the user (e.g. the parent) clicks an Add button 642 to create a new member.

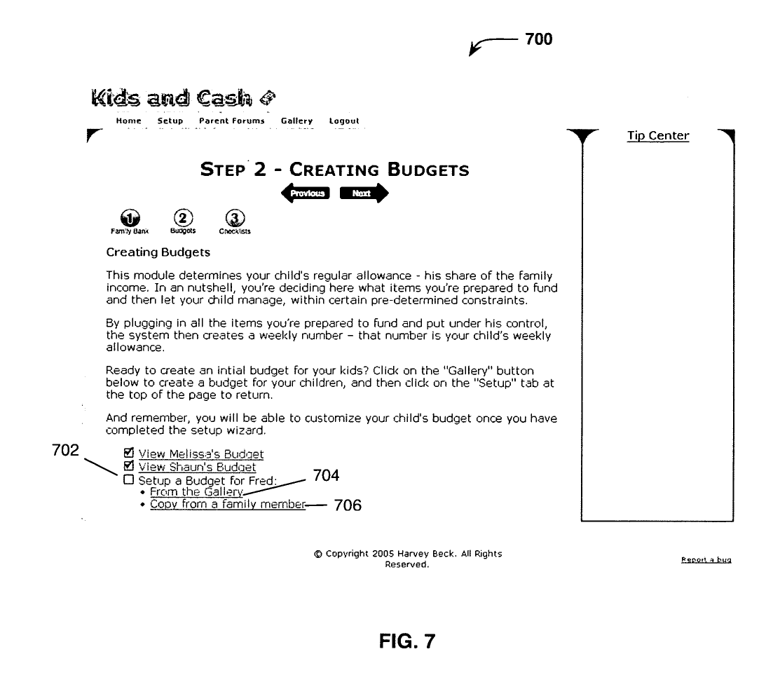

Reference is next made to FIG. 7, which is a screenshot of a Create Budgets page 700 for setting up budgets for the kids using the Setup Wizard facility. As shown, the Create Budgets page 700 includes a “Setup a Budget” click box 702. The Create Budgets page 700 includes a hyperlink 704, which allows the user to select a budget from a saved budget page and modify or customize it for a present family member. The Create Budgets page 700 includes another hyperlink 706, which allows the user to copy a budget page from another family member and then modify it for the present family member. For example, a saved budget page may take the form as shown in FIG. 8.

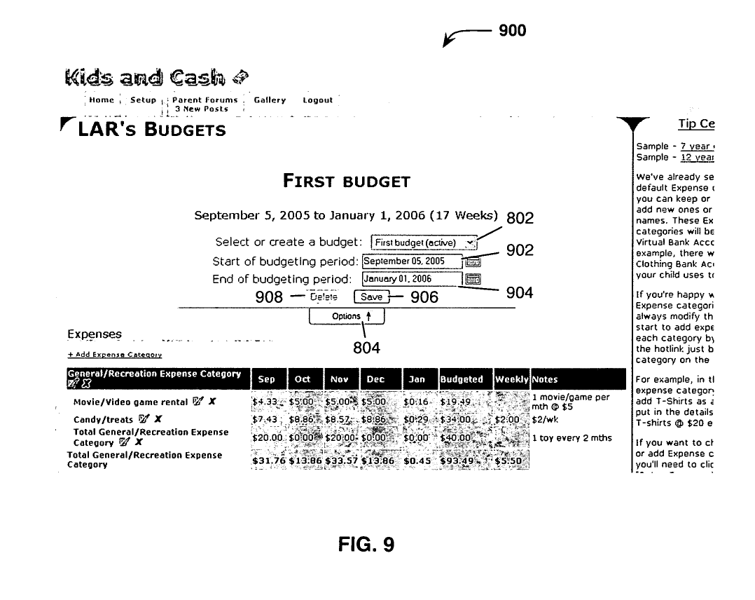

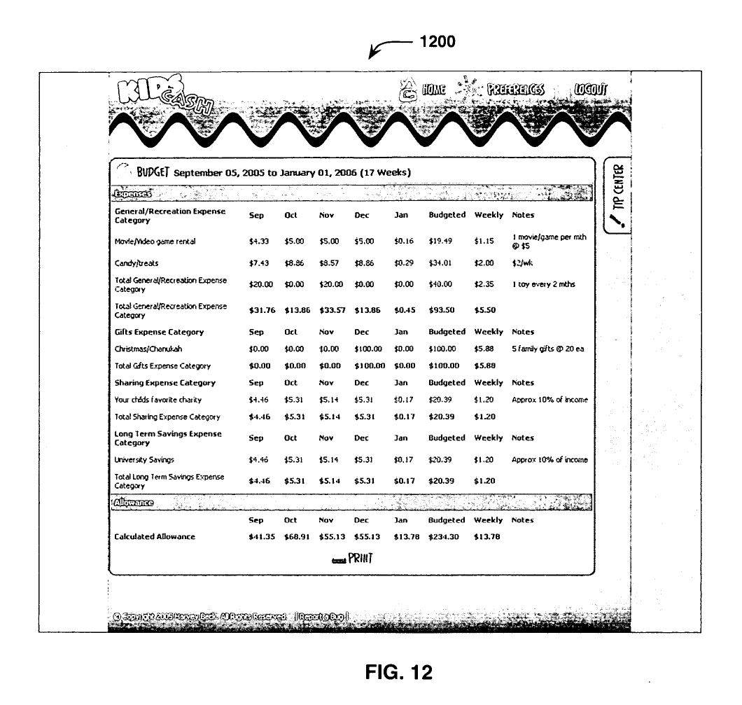

Reference is made to FIG. 8, which is a screenshot of a Budget setup page indicated generally by reference 800. A parent uses the Budget setup page 800 and associated tools to create a Budget page, for example, a Budget page 1200 of the form as shown in FIG. 12, and indicated generally by reference 1200. According to one embodiment of the invention, the Budget page can be created from scratch or by editing an existing Budget page or an exemplary Budget page stored, for example, in the database 118 for the server 112 (FIG. 1). As shown in FIG. 8, the Budget setup page 800 includes a pull-down menu box 802 and an Options button 804 for opening a Budget window 900, for example, having a form as shown in FIG. 9. The Budget window 900 as shown in FIG. 9 is displayed in the top portion of the Budget setup page 800 and comprises the pull-down menu box 802, a Start budgeting period text input box and calendar button 902, an End of budgeting period text input box and calendar button 904, a Save button 906, and a Delete button 908. The parent clicks on the pull-down menu box 802 and selects to “Create a new budget”, which calls up a screen that enables the parent to create a budget from scratch or copy a budget from a family member or from the database (i.e. the database 118 (FIG. 1) on the server 112 (FIG. 1)). The pull-down menu box 802 also provides the parent with a selection to ‘Modify an existing budget’, which allows a parent to change or modify the budget details for that child, i.e. the selected the member. The parent sets the duration of the budget using the Start budgeting period 902 and the End budgeting period 904 buttons.

The selected budget becomes the active budget. In this example, the active budget is labeled a “First Budget”, and comprises a number of “Expense Category” frames. The First Budget as shown in FIG. 8 includes a General/Recreation Expense Category 810, a Clothing Expense Category 820, a Gifts Expense Category 830, a Sharing Expense Category 840 and a Long Term Expense Category 850. Each of the expense categories includes an edit button 860 and a delete button 862, for editing the name of the expense category and deleting the expense category from the budget, respectively. Each of the expense categories comprises one or more expense line items. For example, the General/Recreation Expense Category 810 comprises a Movie/Video game rental expense line item 812, a Candy/Treats expense line item 814, a General/Recreation expense line item 816, and Total General/Recreation Expense category line 818. The Clothing Expense Category 820 includes a single Total Clothing Expense Category line 822; the Gifts Expense Category 830 includes a Christmas/Chanukah expense line item 832 and a Total Gifts Expense Category line 834; the Sharing Expense (i.e. Charitable donation) Category 840 includes a Childs Favorite Charity expense line item 842 and a Total Sharing Expense Category line 844; and the Long Term Savings Expense Category 850 includes a University Saving expense line item 852 and a Total Long Term Savings Expense Category line 854. As shown, each of the expense line items in the expense categories includes an edit button 864 and a delete button 866, for editing and deleting expense line items, respectively. According to one embodiment, the expense categories are mirrored by the bank (virtual) accounts created for the associated family member, for example, as shown in FIG. 22. The Budget setup page 800 includes a Print button 808 for displaying/printing a formatted budget page, for example, as shown in FIG. 12 and indicated by reference 1200. The formatted budget page 1200 includes a Print button 1202 for printing a hardcopy of the budget as shown in FIG. 12.

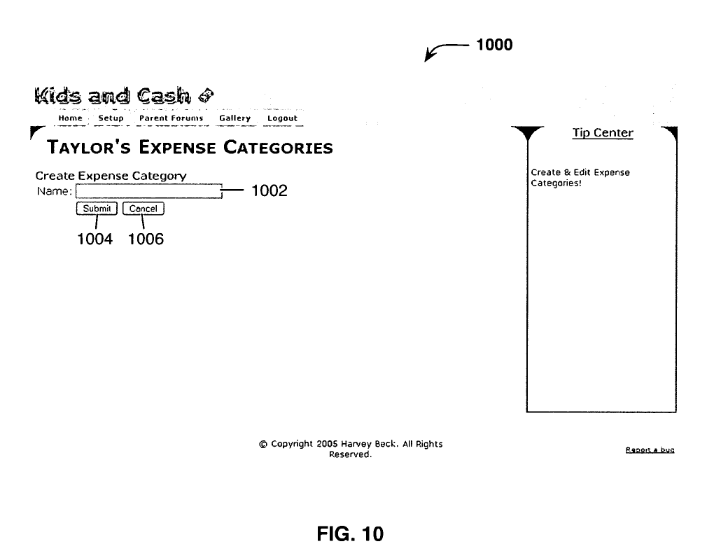

As shown in FIG. 8, the Budget setup page 800 includes an “Add Expense Category” hyperlink 806 for adding/defining additional expense categories. Clicking the Add Expense Category hyperlink 806 displays a Create Expense Category page 1000 as shown in FIG. 10. The Create Expense Category page 1000 includes a text input box 1002 for entering the name of the expense category and a Submit button 1004. The Create Expense Category page 1000 also includes a Cancel button 1006, to cancel the operation and return to the Budget setup page 800. According to one embodiment, a bank account is provided for each of the expense categories (described below with reference to FIG. 14). In other embodiments, one or more accounts are shared by one or more expense categories, i.e. there is not a one-to-one correspondence between the expense categories and the accounts categories.

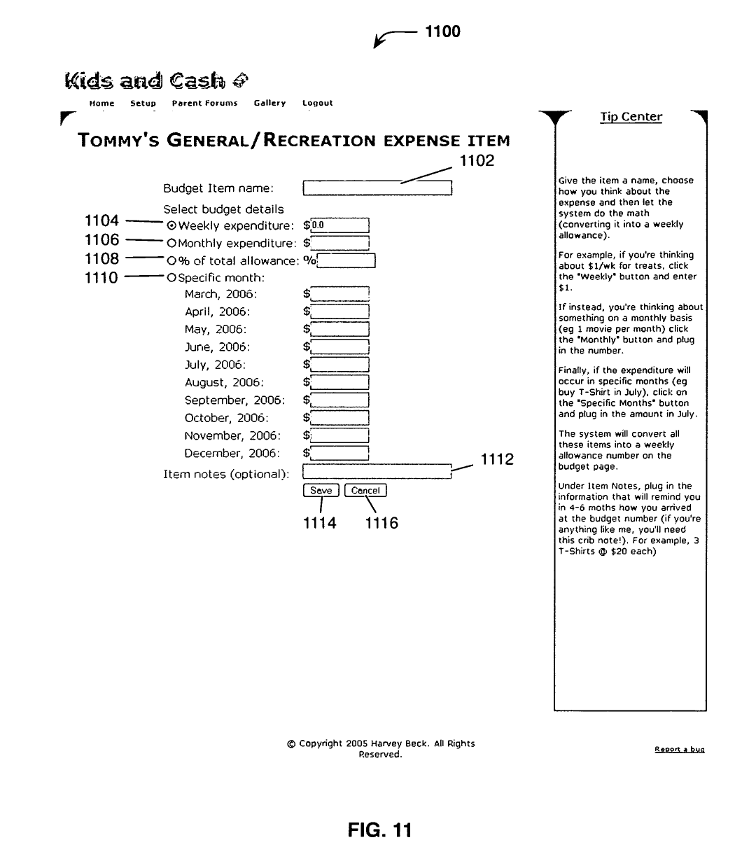

As described above, each of the expense categories includes an Add Expense Item hyperlink 868. In response to a user clicking the Add Expense Item hyperlink 868, the system software 116 (FIG. 1) executes code to display an Expense Item creation page 1100 of a form as depicted in FIG. 11. The Expense Item creation page 1100 includes a text input box 1102 for entering the name of the expense line item, a Weekly expenditure radio button and dollar amount input box 1104, a Monthly expenditure radio button and dollar amount input box 1106, a Percentage of total allowance radio button and percentage amount input box 1108, and a Specific month radio button and dollar amount input box(es) 1110. Using these tools, a parent defines the percentage of allowance allocated to the expense item and whether the expense item is paid on a weekly or monthly basis or for specified months.

Referring again to FIG. 8, the Budget setup page 800 also includes an Income frame 870. As shown, the Income frame 870 comprises a Base Allowance line 872 and a Total Income line 874. The Income frame 870 also includes an Add Income Item hyperlink 876 for adding other income source lines. The Base Allowance line 872 shows the monthly allowance income earned by the child member by way of point rewards for performing tasks defined in the Responsibilities Checklist (as described in more detail below). The Income frame 870 also includes a summary of the total income earned less expenses (i.e. expenditures/withdrawals) and investments made by the child member.

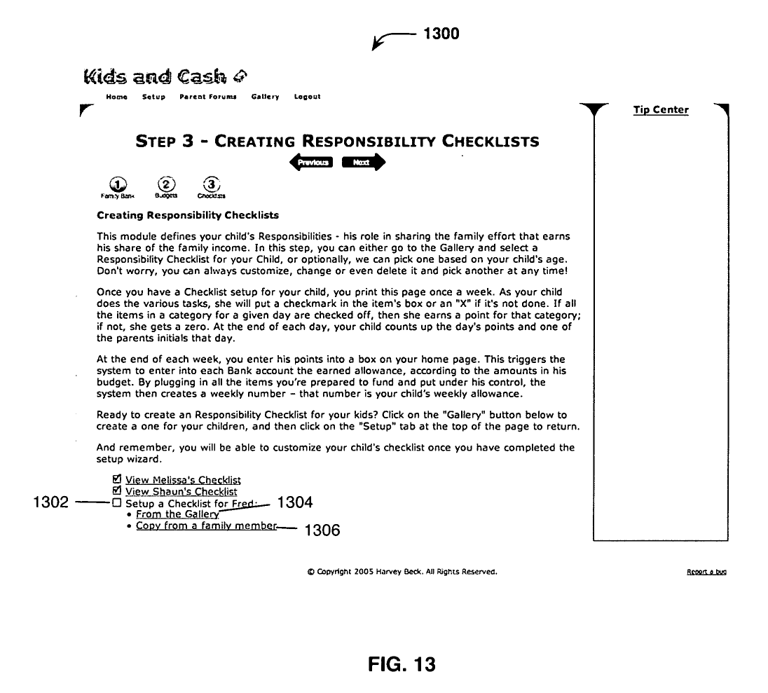

Reference is next made to FIG. 13, which shows a screenshot of a Create Responsibilities Checklist page 1300 for creating responsibilities checklists for the kids using the Setup Wizard facility. As shown, the Create Responsibilities Checklist page 1300 includes a Setup a Checklist click box 1302. The Create Responsibilities Checklist page 1300 includes a hyperlink 1304, which allows the user to select a Responsibilities Checklist from a saved responsibilities checklist and modify or customize it for a present family member. The Create Responsibilities Checklist page 1300 also includes another hyperlink 1306, which allows the user to copy a Responsibilities Checklist from another family member and then modify it for the present family member. The system software 116 (FIG. 1) includes a function or code component which in response to a parent clicking the hyperlink 1304 or 1306 displays a Responsibilities Checklist setup page 1400 having a form for example as shown in FIG. 14.

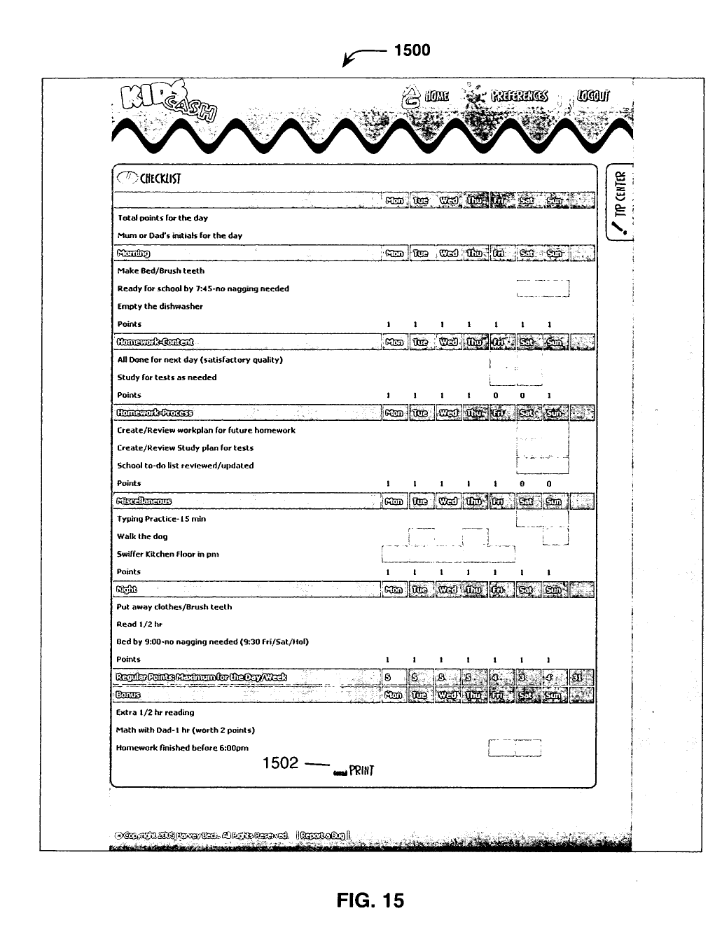

Referring to FIG. 14, the Responsibilities Checklist setup page 1400 allows a parent to define and create a Responsibilities checklist for each child or member of the family. The Responsibilities checklist may comprise a page as shown in FIG. 15 and indicated generally by reference 1500. The Responsibilities checklist 1500 lists the daily/weekly responsibilities (e.g. tasks or chores), which are to be performed by the child in order to earn reward points. The earned reward points are tracked on the Responsibilities checklist and entered into the system 100, for example, on a weekly basis. The software 116 (FIG. 1) includes an allocation mechanism for allocating monetary amounts to the child's accounts (i.e. expense categories) based on the reward points earned. According to another aspect, non-monetary rewards may be provided in lieu of or in addition to the monetary amounts.

As shown in FIG. 14, the Responsibilities Checklist setup page 1400 includes a window or frame 1410 for selecting or creating a Responsibilities Checklist. The Responsibilities Checklist may be created from scratch or as a modified/edited version of an existing Responsibilities Checklist, for example, for another family member or from a precedent or example checklist stored in the database 118 (FIG. 1) on the server 112 (FIG. 1). As shown, the Responsibilities Checklist window 1410 includes a pull-down menu 1412 for selecting an existing checklist or creating a new checklist, a pull-down menu 1413 for selecting the starting day of the week, e.g. Monday, for the checklist responsibilities, a Print button 1414 and a Delete button 1415.

Referring to FIG. 14, the responsibilities for a family member are arranged in categories and each category includes one or more responsibility items (e.g. tasks or chores to be completed by the child in order to earn a reward point for the associated day). For exemplary embodiment depicted in FIG. 14, the responsibility categories comprise a Morning responsibilities category 1420, a Homework-Content responsibilities category 1430, a Homework-Process responsibilities category 1440, a Miscellaneous responsibilities category 1450, and Nighttime responsibilities category 1460. The Responsibilities Checklist may also include a Bonus points category indicated by reference 1470. Each of the responsibilities categories include an edit button 1480 and a delete button 1482, for editing the name of the category or deleting the category from the checklist, respectively. As shown, the Morning category 1420 comprises a Make Bed/Brush teeth responsibility item 1422, a Ready for School responsibility item 1424, and an Empty dishwasher responsibility item 1426. Each responsibility item includes checkboxes for the respective days of the week. Certain responsibilities are not performed everyday of week, for example, Ready for School 1424, and the checkbox for Saturday and Sunday is blocked out. The Homework-Content category 1430 comprises an All Done for next responsibility item 1432 and a Study for Tests as needed responsibility item 1434. The Homework-Process category 1440 comprises a Create/Review work plan responsibility item 1442, a Create/Review Study plan responsibility item 1444, and a School to-do list responsibility item 1446. The Miscellaneous category 1450 includes a Typing practice responsibility item 1452, a Walk the Dog responsibility item 1454, and a Swiffer Kitchen Floor responsibility item 1456. The Night category 1460 comprises a Put Away Clothes/Brush Teeth responsibility item 1462, a Read responsibility item 1464, and to Bed without nagging responsibility item 1466. The Bonus category 1470 includes an Extra reading reward 1472, a Math with Dad reward (worth double points, i.e. 2 points) 1474, and a Homework finished early reward 1476.

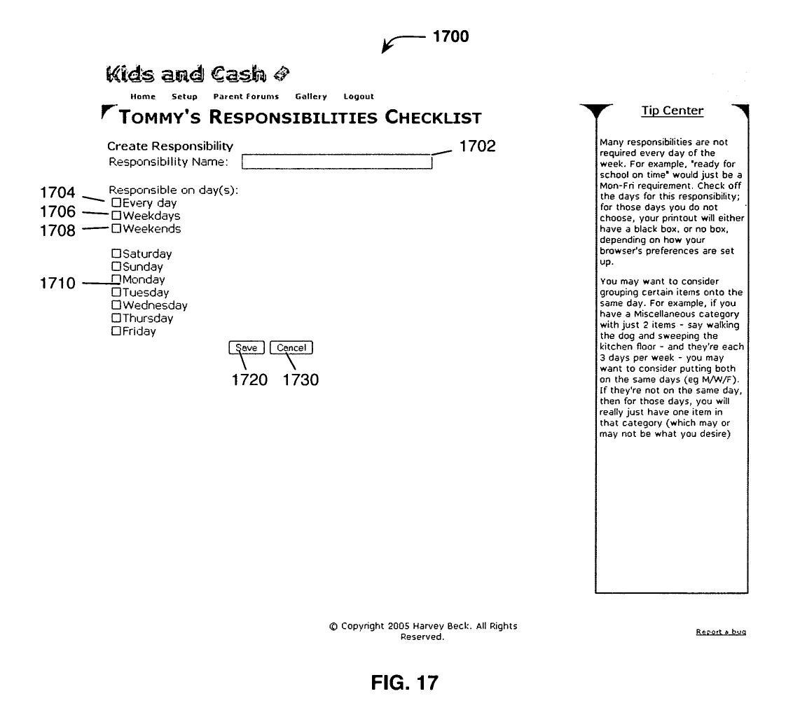

In addition to the Edit 1480 and delete 1482 buttons, each of the responsibility categories 1420 to 1460 includes an Add Responsibility Item hyperlink, indicated generally by reference 1484. In response to the Add Responsibility Item hyperlink 1484 being ‘clicked’, the software 116 (FIG. 1) displays a Create Responsibility page 1700 for example as shown in FIG. 17. As shown in FIG. 17, the Create Responsibility Item page 1700 comprises a text input box 1702 for inputting the name of the responsibility item, and checkboxes for assigning everyday of week 1704, weekdays 1706, weekends 1708, or individual days of week 1710 for performance of the responsibility. In response to the parent clicking a Save button 1720, the software 116 executes a function or code to add the new responsibility item to the Responsibility Checklist setup page 1400. The Create Responsibility Item page 1700 also includes a Cancel button 1730 to return to the previous page without saving the new responsibility item.

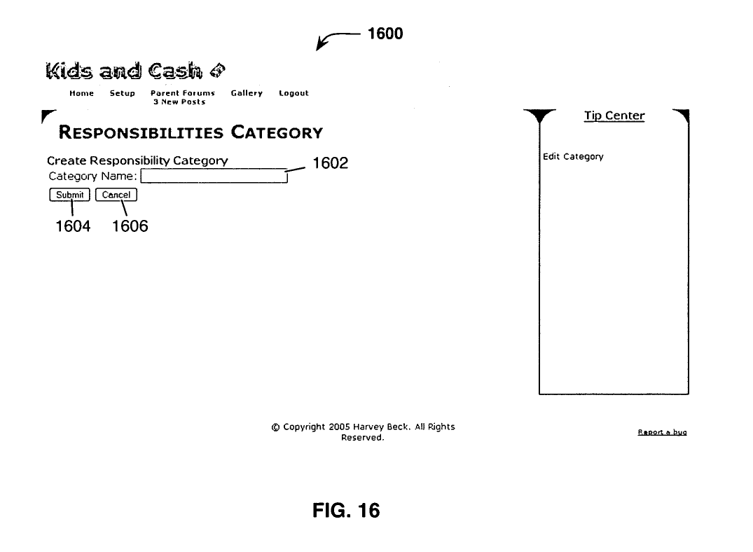

As also shown in FIG. 14, the Responsibilities Checklist setup page 1400 includes an Add Category hyperlink 1416. The parent clicks the Add Category hyperlink 1416 to add a new responsibility category, for example, a Sports responsibilities category comprising the following responsibility items, soccer practice, karate practice and golf lessons. In response to a parent clicking the hyperlink 1416, the software 116 (FIG. 1) executes a function, routine or code, which displays a Responsibility Category Create page 1600 as shown in FIG. 16. The Responsibility Category Create page 1600 includes a text input box 1602 for entering the name of the new responsibility category and a Submit button 1604 for saving the new category, i.e. adding it to the Responsibilities Checklist setup page 1400 in FIG. 14. The Responsibility Category Create page 1600 includes a Cancel button 1606 to cancel the operation and return to the previous page, e.g. the Responsibilities Checklist setup page 1400. The responsibilities items are defined/populated using the Add Responsibility Item link 1484 as described above.

It will appreciated that the Responsibilities Checklist setup page 1400 depicted in FIG. 14 and the formatted Responsibilities Checklist 1500 depicted FIG. 15 are but one example of a responsibilities checklist for a family member. The tools, e.g. Add Category 1416, Add Responsibilities Item 1484, Edit buttons 1480 and 1482, provided in the setup page 1400 allow a parent to create and customize responsibilities for each member of the family.

Once the parent is satisfied with the responsibilities checklist, or simply wishes to preview a hardcopy of the checklist, the parent clicks a Print button 1418 on the Responsibilities Checklist page 1400 to print the checklist. In response to the Print button 1418, the software 116 (FIG. 1) sends the checklist directly to a printer or print spooler, or the software 116 can include a function or code component to display a formatted Responsibilities Checklist for example as shown in FIG. 15. The page for the formatted Responsibilities Checklist 1500 includes a Print button 1502 for printing the checklist.

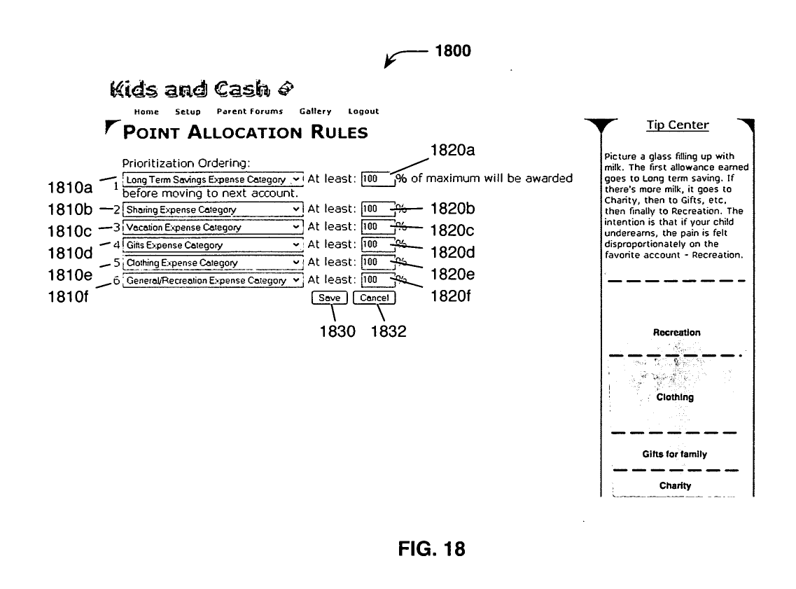

As described above, the Responsibilities Checklist 1500 provides a mechanism for tracking the completion of individual responsibilities on a daily basis and recording points for the successful completion of each of the responsibilities. At the end of the week, or other selected time period, a point total for each family member is entered into the system 100 and the system software 116 (FIG. 1) executes a function, routine or code, to allocate rewards (e.g. monetary amounts) to each of the accounts (i.e. expense categories) based on the point total. The home page 500 as described above with reference to FIG. 5 includes an Enter Checklist Points window or frame 538 (FIG. 5) and a Submit All Points tab 542 (FIG. 5) for each family member window 520 (FIG. 5). According to one embodiment, the software 116 (FIG. 1) executes an allocation function in response to the parent entering the point totals (i.e. weekly point totals) and clicking the Submit All Points tab 542. According to one embodiment, the allocation function calculates the allowance by dividing the point total by the maximum number of points times the base allowance. The calculated allowance, e.g. weekly allowance, is divided by the number of accounts for the family member, and an equal monetary amount is deposited into each account. According to another embodiment, the allocation function comprises a weighted function that allows the parent to allocate percentage deposits to each of the family member's accounts. According to another embodiment, the allocation function includes a mechanism for setting an account priority or ordering of accounts. Reference is made to FIG. 18, which shows a Point Allocation Rules setup page 1800 according to the embodiment of the invention.

The Point Allocation Rules setup page 1800 for each child member is accessed by clicking the Prefs hyperlink 550 on the Home page 500 (FIG. 5(a)). As shown in FIG. 18, the Point Allocation Rules setup page 1800 includes a column of pull-down menu boxes 1810 and a corresponding column of text input boxes 1820. The pull-down menu boxes 1810, indicated individually by references 1810a, 1810b, 1810c, 1810d, 1810e and 1810f, are used to select individual expense categories, i.e. accounts, and set a priority or order for allocating reward amounts between the respective accounts. According to this embodiment, the allocation priority ranges from highest for the account in the pull-down menu box 1810a to the lowest for the account in the last pull-down menu box 1810f. The text input boxes 1820, indicated individually by references 1820a, 1820b, 1820c, 1820d, 1820e and 1820f, allow a parent to set the maximum percentage share of the budgeted amount to be allocated to each of the expense categories in order of priority. For the example depicted in FIG. 18, the percentage share is set to 100%, which means that the earned rewards, e.g. earned allowance, is divided between the six expense categories based on the budget allocations defined in the Budget setup page (FIG. 8). In another embodiment, each of the expense categories does not have a respective or corresponding account, rather one or more accounts are shared or allocated to the expense categories. As described above, the earned allowance is calculated according to the following equation:
Earned Allowance=earned point total/regular point maximum*base allowance (1)
As shown the Points Allocation Rules setup screen 1800 includes a Save button 1830 and a Delete button 1832. Clicking the Save button 1830 saves the entered account priorities 1810 and the entered allocation percentages 1820 in memory, for example, on the server 112 (FIG. 1). As will be described below, the account priorities or account order and the allocation percentages serve as parameters for an allocation process executed by the software 116 (FIG. 1).

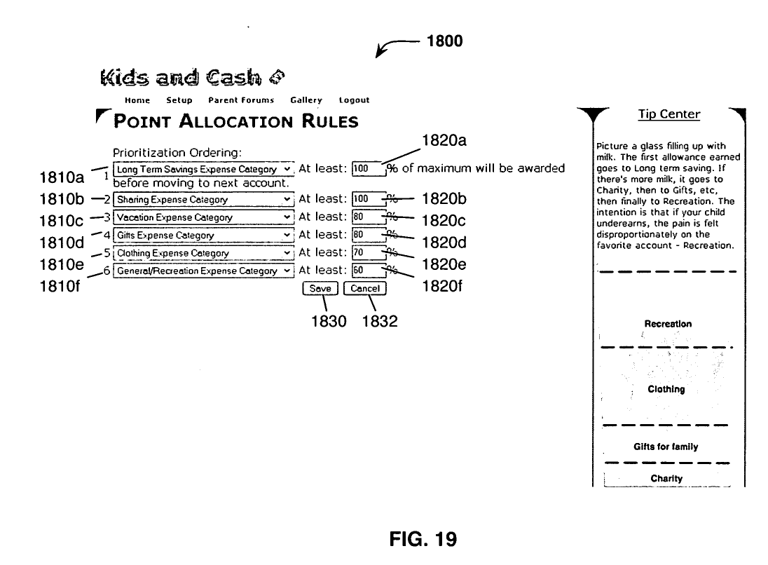

In situations, where the family member does not earn the maximum available points for a week, the Point Allocation Rules setup page 1800 allows a parent to prioritize or order the accounts for the distribution of the awards and/or allocate a larger or a lower percentage to any of the accounts. For example as shown in FIG. 19, the Long Term Savings account in box 1810a and the Sharing Expense account 1810b are defined as high priority accounts, and the Long Term Saving account 1810a is configured to receive 100% of the budget allocation, and similarly the Sharing Expense account 1810b is configured to receive 100% of the budget allocation provided there are sufficient funds available in the remaining allowance. As shown in FIG. 19, the allowance percentages for the remaining four accounts are set to 80%, 80%, 70% and 60%, of the budget allocations, respectively. This means that if the family member earns less than the maximum points for the week, his or her clothing expense and general expense accounts will receive whatever is left over after distribution to the higher priority accounts. In other words, if a child under earns, i.e. by not fulfilling all of his or her responsibilities, the reward distribution may be configured to reflect the reward shortfall in his or her favorite account or expense category, e.g. the General/Recreation Expense account.

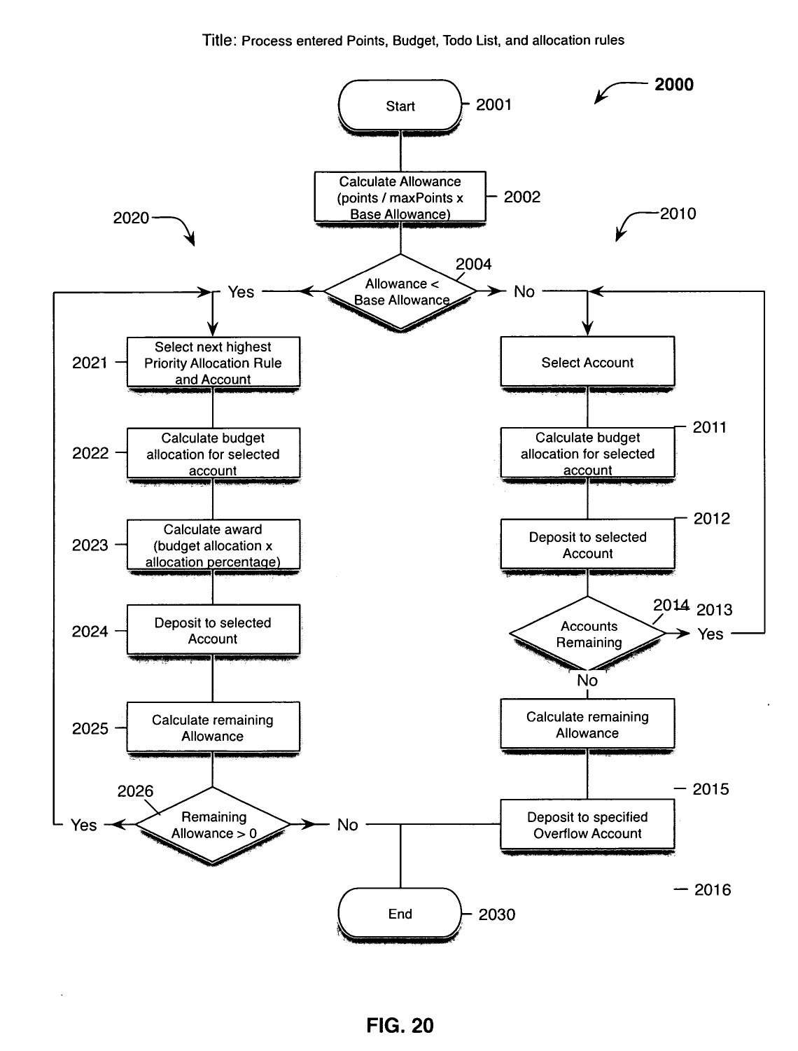

Reference is next made to FIG. 20, which shows in flowchart form an allocation process according to an embodiment of the invention and indicated generally by reference 2000. The allocation process 2000 is implemented as a function, routine or other code component in the system software 116 (FIG. 1). The start of the process is indicated by step 2001 and the termination of the process is indicated by step 2030. As shown, the first processing step in block 2002 comprises calculating the earned allowance for the selected period (e.g. week), which comprises executing equation (1) as described above. The next step comprises a decision block 2004 and involves determining whether the calculated allowance is less than the base allowance amount. As described above, the base allowance is the desired expenditures to be allocated among the expense categories defined in the budget for the family member. If the calculated allowance is greater than or equal to the base allowance (as determined in decision block 2004), then the process 2000 comprises executing an allocation procedure 2010 where the calculated allowance is allocated between the accounts according to the budget allocations and the percentages defined in the Points Allocation page 1800 (FIG. 18), i.e. the allowance percentages specified in boxes 1820 (FIG. 18). If the calculated allowance is less than the base allowance, i.e. there is shortfall in the earned allowance, then it is not possible to distribute the earned allowance to the accounts according to the budget allocations. The allocation is performed according to the priority of accounts as defined in the column comprising the boxes 1810 and according to the allowance percentages specified in the boxes 1820 in FIG. 18.

Referring to FIG. 20, the first step in the allocation procedure 2010 comprises selecting an account in block 2011. The next step in block 2012 comprises calculating a budget allocation for the account selected in block 2011. The budget allocation amount is determined from the Budget page 800 (FIG. 8) for the selected account or expense category. If the expense category or account has more than one expense item, e.g. the General Expense Category 810 (FIG. 8), then the budget allocation amount is distributed to the respective expense items, and the balance of the account is updated. The balance for each account belonging to a family member is displayed for example as shown in FIG. 22. The allocation procedure in blocks 2011 to 2013 is repeated until all the expense categories (and associated expense items) have been updated as determined in decision block 2014. Next in block 2015, a calculation is made to determine if any allowance is left over. Any left over allowance is deposited to a specified overflow account, for example, the Long Term saving account or a separate overflow account. It will be appreciated that the earning of bonus points, which are added to the base points, results in a calculated allowance, which is greater than the base allowance.

Referring again to FIG. 20, if the calculated allowance is less than the base allowance, then there is a shortfall in the amount that can be allocated to the accounts (i.e. according to the budget allocations defined in FIG. 8), and the funds are allocated to the accounts according to the priority and the allocation percentages defined in FIG. 18. As shown in FIG. 20, the first step, i.e. block 2021, in the shortfall allocation procedure 2020 comprises selecting the highest priority account (i.e. according to the defined priority in the Point Allocation setup page 1800 in FIG. 18 or FIG. 19). The shortfall allocation procedure 2020 comprises a loop, which is executed until the earned allowance has been completely allocated between the accounts (i.e. the earned allowance is zero as determined in decision block 2026). In step 2021, the account or expense category with the highest priority is selected. For example, referring to FIG. 19, the Long Term Savings account 1810a is selected the first time that the procedure 2020 is executed. In subsequent iterations of the procedure 2020, the Sharing Expense account 1810b is selected, followed by the Vacation Expense account 1810c, . . . and so on, ending with the General/Recreation Expense account 1810f, provided of course there funds remaining in the calculated allowance. In step 2022, the allocation procedure 2020 determines the budget allocation for the account or expense category, selected in step 2021. The budget allocation is determined, for example, from the budget 800 (FIG. 8) as described above. Next in step 2023, the allocation procedure 2024 calculates the reward amount by multiplying the budget allocation amount (i.e. from block 2022) by the allowance percentage for the selected account. As described above, the allowance percentage is determined according to the specified value in box 1820 in the Point Allocation Rules page 1800 (FIG. 18). The award amount calculated in step 2023 is then deposited to the selected account in step 2024. In step 2025, the procedure updates the available allowance amount by subtracting the amount deposited in step 2024 from the allowance amount. If the allowance amount calculated in step 2024 is greater than zero (i.e. as determined in the decision block 2026), then the shortfall allocation procedure 2020, i.e. steps 2021 to 2026, is repeated. Otherwise, the earned allowance has been allocated to the child's accounts according to the point allocation rules (FIG. 18), and control is returned to the calling function in the computer program 116 (FIG. 1).

According to another aspect, the responsibilities-based reward allocation and management system 100 provides a “kids portal” for the child members. The kid's portal allows a child member to access the system 100 and see information concerning their accounts and perform certain functions, such as printing checks for withdrawing funds, as will be described in more detail below. To access the system 100, a child member is assigned a “username” and “password”, for example, by the parent as part of the setup process. The child enters his username 2110 in the Username box 304 and his password 2120 in the Password box 306 and clicks the Submit button 308 as depicted in FIG. 21. In response, the system software or computer program 116 (FIG. 1) executes a function or routine, which displays a Kid's Portal Home page, for example, as shown in FIG. 22(a) and indicated generally by reference 2200. As shown, the Kid's Portal Home page 2200 includes a Message Center frame or window 2210, a Bank Account frame or window 2220, and an Allowance History frame or window 2230. The Kid's Portal Home page 2200 may also include a Photo frame 2240 for showing a scanned photo or digitized image of the family member, a family pet, a favorite toy, etc.

As shown in FIG. 22(a), the Message Center frame 2210 displays messages. The messages may originate from a parent, other family member, the system administrator, etc. Unread messages are marked as “New” and include a subject line. A Delete button is provided for deleting read or unread messages. The Message Center frame 2210 also includes a Close button 2212 for closing or hiding the frame 2210. Clicking on a message, for example, the “New” label displays a Messages window 2250, for example, of the form as shown in FIG. 22(b). As shown in FIG. 22(b), the Messages window 2250 comprises a frame or screen 2252 which includes a Date field or line 2254, a From field or line 2256, a Subject field or line 2258, and a message body 2260. As also shown, the Messages window 2250 also includes a Back button 2262 to return to the Kid's Portal Home page 2200 and a Delete button 2264 to delete the message.

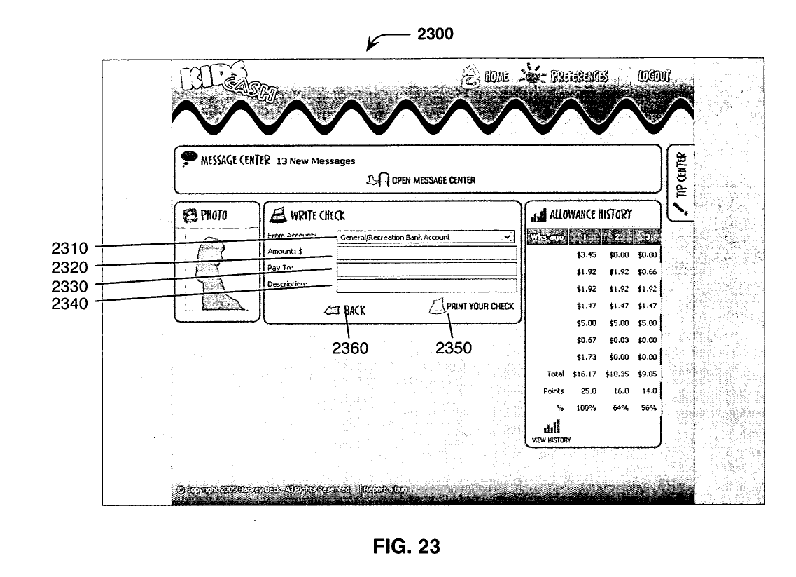

The Family Bank frame 2220 displays the child's accounts in the family bank and the corresponding account balances. As described above, the accounts correspond to the expense categories defined in the budget according to one embodiment. For the example shown in FIG. 8, the child's family bank includes a General/Recreation Bank Account (i.e. with a balance of $38.19), a Clothing Bank Account, a Gifts Bank Account, a Sharing Bank Account and a Long Term Savings Bank Account. As shown, the child's family bank also includes a Scholastic Books Account and an Other Account. The Other Account may be used for depositing overflow funds, for example, as described above with reference to FIG. 20. As also shown, the Family Bank frame 2220 includes a Write Check button 2222. Clicking the Write Check button 2222 allows the child to requisition and print a check. In response to the Write Check button 2222 being clicked, the computer program 116 (FIG. 1) executes a function or routine which displays a Write Check page, for example, having a form as shown in FIG. 23 and indicated generally by reference 2300. In another embodiment, the accounts are assigned or associated to more than one expense category.

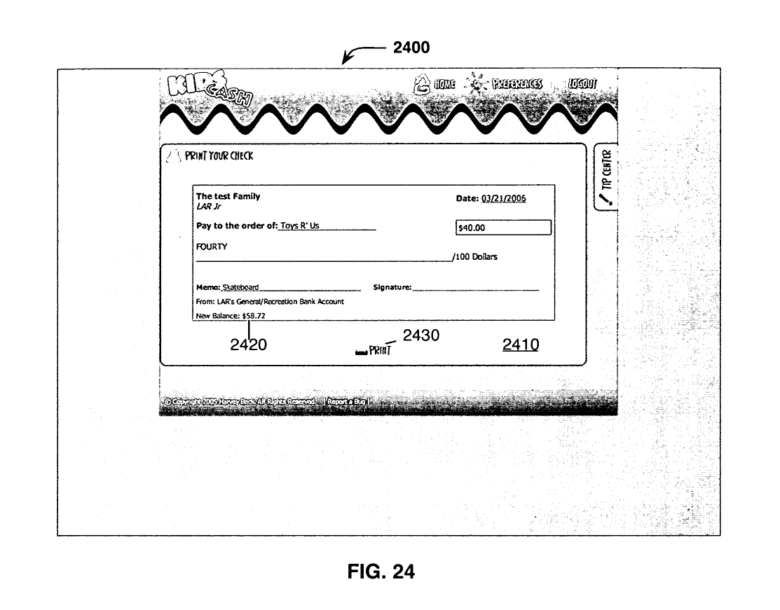

As shown in FIG. 23, the Write Check page 2300 includes a From Account pull-down menu box 2310, an Amount text box 2320, a Pay To text input box 2330, and a Description text input box 2340. In addition, the Write Check page 2300 includes a Print Your Check button 2350 and a Back button 2360. To write a check, the family member (e.g. the child) selects the account (e.g. the General/Recreation Bank Account) in the From Account pull-down menu 2310, and enters the dollar amount (e.g. $40.00) in the Amount input box 2320. The family member enters the payee name in text box 2330 and memo or description information in the text box 2340, as additional information to be printed on the check. The computer program 116 (FIG. 1) may be configured to make these last two steps optional. Once the family member is satisfied, he or she clicks the Print Your Check button 2350 and in response the computer program 116 (FIG. 1) executes a function or routine to display a Print Check view, for example, having a form as shown in FIG. 24 and indicated by reference 2400. The Print Check view 2400 includes a check frame or window 2410 which displays the check in formatted form and including the information entered in the Write Check page 2300 (FIG. 23), for example, the payee, bank account name, amount of check, and description. The computer program 116 (FIG. 1) may also include a function or routine, which calculates a updated balance and displays a New Balance field indicated by reference 2420 in the check frame 2410. It will be appreciated that displaying the updated account balance in the New Balance field 2420 may lead to the family member re-evaluating the impact of the planned expenditure. To print the check, the family member clicks a Print button 2430 in the Print Check view 2400.

Referring back to FIG. 22(a), the Allowance History frame or window 2230 displays or lists the earned allowance amounts received by the family member on a weekly basis. As shown, the Allowance History frame 2230 may be aligned with the Family Bank frame 2220 to show a breakdown of the weekly-earned allowance amounts on an account-by-account basis. The Allowance History frame 2230 includes a percentage “%” earned row indicated by reference 2232, which indicates the percentage of the available allowance actually earned by the family member. For the example shown, the family member earned 100% of the available allowance for Week 1, then 64% for Week 2 and then only 56% for Week 3. The Allowance History frame 2230 also includes a View History button 2234, which allows the family member to view additional allowance weeks, for example, as indicated by reference 2232.

The present invention may be embodied in other specific forms without departing from spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for allocating a reward based on a point total, said system comprising:
a list comprising one or more responsibilities, and completion of each of said responsibilities providing a point towards the point total;
two or more accounts, each of said accounts being adapted to accept the reward or a portion of the reward;
a calculator for calculating the reward, the reward being based on the point total; and
an allocator for allocating the reward between said two or more accounts.

2. The system as claimed in claim 1, wherein said allocator includes a priority mechanism, said priority mechanism assigning a priority to each of said accounts, and the reward being allocated to each of said accounts based on the assigned priority associated with said account.

3. The system as claimed in claim 2, wherein said allocator includes a percentage allocation mechanism, said percentage allocation mechanism defining a percentage allocation for each of said accounts, and said allocator allocating a portion of the reward to each of said accounts, wherein said portion is based on the percentage allocation defined for said account.

4. The system as claimed in claim 1, wherein said responsibilities list includes one or more bonus responsibilities, and completion of said bonus responsibilities results in bonus points being added to the point total.

5. The system as claimed in claim 4, wherein said allocator includes a percentage allocation mechanism, said percentage allocation mechanism defining a percentage allocation for each of said accounts, and said allocator allocating a portion of the reward to each of said accounts based on the percentage allocation defined for said account.

6. The system as claimed in claim 5, wherein said system includes an overflow account, said overflow account receiving any excess reward portion resulting from the bonus points.

7. A method for allocating a reward based on a point total, said method comprising the steps of:
providing a list comprising one or more responsibilities, wherein completion of each of said responsibilities results in a point for the point total;
providing two or more accounts, each of said accounts being adapted for receiving the reward or a portion of the reward;
calculating a reward amount based on the point total; and
allocating the reward amount to said two or more accounts.

8. The method as claimed in claim 7, wherein a plurality of said responsibilities comprise a responsibilities group and a point amount is given for completion of each of the responsibilities belonging to said responsibilities group, and said point amount is applied to said point total.

9. The method as claimed in claim 8, wherein said step of allocating comprises defining a priority for each of said accounts, and said reward amount being allocated to each of said accounts based on said defined priority.

10. The method as claimed in claim 7, wherein said step of allocating comprises defining a percentage allocation for each of said accounts, and said reward amount being allocated to each of said accounts based on the percentage allocation for said account.

11. A system for allocating a reward based on a point total, said system comprising:
a list comprising one or more responsibilities, wherein completion of each of said responsibilities provides a point towards the point total;
a plurality of expense categories, each of said expense categories having a budget allocation;
a plurality of accounts, each of said accounts being adapted to accept the reward or a portion of the reward according to said budget allocation;
a calculator for calculating the reward, the reward being based on the point total and a budget allowance; and
an allocator for allocating the reward between said accounts, said allocation being based on the budget allocation for said corresponding expense category.

12. The system as claimed in claim 11, wherein said allocator includes a percentage share mechanism, said percentage share mechanism defining a percentage share for each of said expense categories, and said allocator allocating a portion of the reward to each of said accounts, wherein said portion is based on the percentage share of the budget allocation for said expense category.

13. The system as claimed in claim 12, wherein a plurality of said responsibilities comprise a responsibilities group and a point amount is given for completion of each of the responsibilities belonging to said responsibilities group, and said point amount is applied to said point total.

14. The system as claimed in claim 13, wherein each of said expense categories is associated with one of said plurality of accounts, and each of said accounts being configured to accept at least a portion of the reward.

15. The system as claimed in claim 11, wherein said allocator includes a priority mechanism, said priority mechanism assigning a priority to each of said expense categories, and the reward being allocated to each of said accounts based on the assigned priority associated with said corresponding expense category.

16. The system as claimed in claim 15, wherein said allocator includes a percentage share mechanism, said percentage share mechanism defining a percentage share for each of said expense categories, and said allocator allocating a portion of the reward to each of said accounts, wherein said portion is based on the percentage share of the budget allocation for said corresponding expense category.

17. The system as claimed in claim 11, further including a portal for providing access for a member, said portal including a window for displaying said accounts and corresponding balances for said member.

18. The system as claimed in claim 17, wherein said portal includes a code component for requesting a withdrawal from one of said accounts by said member.

19. The system as claimed in claim 18, wherein said code component comprises a window for requisitioning a check, said window including a code component for printing said requisitioned check.

20. The system as claimed in claim 11, wherein said responsibilities are grouped into one or more responsibility categories on said list, and each of said responsibility categories comprises one or more responsibility items, and wherein completion of the responsibility items in each of said responsibility categories results in a point.

21. The system as claimed in claim 20, wherein each of said expense categories comprises one or more expense items, and portion of the budget allocation for each of said expense categories is assigned to the respective expense items.

22. The system as claimed in claim 21, further including a component for defining a budget page, said budget page comprising said expense categories and said associated expense items, and each of said expense items including a budget amount, and said budget amounts forming the budget allocation for said associated expense category.

23. The system as claimed in claim 22, said budget page component includes a code component for changing any of said budget amounts, and a code component for adding an expense category.

24. A network-based system for allocating a reward based on a point total, said system comprising:
a server coupled to a network;
said network including a plurality of ports for coupling user stations to said network for communicating with said server;
said server including a component for generating a responsibilities list for any one of said users, said responsibilities list comprising one or more responsibilities, and completion of each of said responsibilities providing a point towards the point total;
said user station including a component for transmitting to said server a point total associated with said user;
said server including a component for defining two or more accounts for any one of said users, each of said accounts being adapted for accepting the reward or a portion of the reward for said user associated with said accounts;
said server including a component for calculating the reward for said user based on the point total received from said user;
said server including a component for allocating said calculated reward to the two or more accounts associated with said user;
said server including a component for sending a page to said user showing the allocation of said reward to said two or more accounts.

25. The network-based system as claimed in claim 24, wherein each of said accounts comprises an expense category and a virtual bank account, and each of said expense categories includes a budget allocation, and wherein said component for allocating said calculated reward is responsive to the budget allocation for the expense category associated with said account.

26. The network-based system as claimed in claim 25, wherein said component for allocating includes a percentage share component, said percentage share component defining a percentage share for each of said expense categories, and said allocator component distributing a portion of the reward to each of said corresponding accounts, wherein said distributed portion is based on the percentage share of the budget allocation for said expense category.

27. The network-based system as claimed in claim 25, wherein said component for allocating includes a priority order component, said priority order component establishing a priority order for said expense categories, and said component for allocating being responsive to said priority order and allocating the reward to said accounts according to said priority order.

28. The network-based system as claimed in claim 24, wherein said component for generating a responsibilities list comprises a responsibilities setup page, said responsibilities setup page comprising a plurality of frames, each of said frames corresponding to a responsibility category, and each of said responsibility categories including one or more responsibility items, and said responsibilities setup page including a code component for adding one or more new responsibility categories and a code component for adding one or more new responsibility items, and said server including a code component for transmitting said responsibilities setup page to any one of said user stations.

29. The network-based system as claimed in claim 25, wherein said component for defining two or more accounts comprises a budget setup page, said budget setup page comprising a plurality of frames, each of said frames comprising an expense category, and each of said expense categories including one or more expense items, and said budget setup page including a code component for defining a budget allocation associated with each of said expense items.

30. A computer data signal embodied in a carrier wave, said carrier wave comprising:
a responsibilities-based reward allocation portal page code segment;
said portal page code segment comprising one or more member windows, and each of said member windows including a responsibilities page code segment, a budget page code segment, and a point entry window.

31. The computer data signal embodied in a carrier wave as claimed in claim 30, wherein said responsibilities page code segment comprises a hyperlink for downloading a responsibilities setup page code segment.

32. The computer data signal embodied in a carrier wave as claimed in claim 31, wherein said budget page code segment comprises a hyperlink for downloading a budget setup page code segment.

33. The computer data signal embodied in a carrier wave as claimed in claim 32, wherein said point entry window includes a code segment for receiving a point total and transmitting said point total to a server, said server including a code component for generating a reward based on said point total, a code component for allocating said reward to two or more accounts, said accounts being defined in said budget setup page.

34. The computer data signal embodied in a carrier wave as claimed in claim 33, wherein said server includes a code component for generating a budget page showing allocation of said reward, and a code component for transmitting said budget page as a code segment in said computer data signal.
